(19) United States
(12) Patent Application Publication
(10) Pub. No.: US 2017/0175523 A1
(43) Pub. Date: Jun. 22, 2017

(54) THERMAL EXTRACTION GEOCHEMICAL METHOD FOR MEASUREMENT OF OIL IN PLACE AND MOVABLE OIL IN LIQUID RICH FINE GRAIN ROCKS

(71) Applicant: APACHE CORPORATION, Houston, TX (US)

(72) Inventor: Michael A. Abrams, La Grange, TX (US)

(73) Assignee: APACHE CORPORATION, Houston, TX (US)

(21) Appl. No.: 15/129,880

(22) PCT Filed: Mar. 30, 2015
(86) PCT No.: PCT/US2015/023355

§ 371 Date: Sep. 28, 2016

Related U.S. Application Data
(60) Provisional application No. 61/972,786, filed on Mar. 31, 2014.

(51) Int. Cl. E21B 49/08; G01N 30/68

(52) U.S. Cl. CPC E21B 49/08; G01N 30/68; G01K 17/00

(57) ABSTRACT

A method for analyzing total oil in place and fraction that is movable oil in a fine gain rock formation includes monitoring thermal extraction of hydrocarbon and non-hydrocarbon compounds from a sample of a subsurface formation by heating the sample. The heating has a selected initial temperature, and a temperature increase at a selected rate to a final temperature. The extracted hydrocarbon and non-hydrocarbon compounds are passed through a capillary column to a flame ionization detector. Types of hydrocarbon and non-hydrocarbon compounds and relative fractional amounts of each type thereof are determined from the sample by analyzing a chemical thermogram generated by the flame ionization detector.

### BACKGROUND

This disclosure is related to the field of analysis of extracted oil from samples of subsurface formations withdrawn from wells drilled through such formations. More specifically, the disclosure relates to methods for performing tests on such samples to quantify the total oil in place and which fraction of the in place oil is movable in such formations.

Oil-in-place (OIP) and movable oil (MO) analysis of subsurface formations traversed by a wellbore has been carried out with petrophysical analysis (analysis of measurements of selected physical properties made by sensors disposed in a wellbore) and some limited geochemical measurements of formation samples withdrawn from wellbores (e.g., programmed pyrolysis). Some studies suggest that programmed pyrolysis S1 (free hydrocarbon measurement) could be used to evaluate direct measurements of inplace oil in such formations. One major petroleum producing company has developed a pyrolytic method to quantitatively assess reservoir quality from residual oil staining on drill cuttings in real time (Jones et al. 2007, Implementation of Geochemical Technology for real Time Tar Assessment and Geosteering: Saudi Arabia). Another major petroleum producing company has developed a proprietary programmed pyrolysis S1 OIP analysis (Michels et al., 2013, Determination of in-situ hydrocarbon volumes in liquid rich shale plays, URTec meeting paper). The foregoing method uses analysis programs known by the trademark ROCK-EVAL which is a registered trademark of IFP Energies Corporation, 1 et 4, avenue du Bois-Preau 92 Rueil-Malmaison, Cedex 92852, France and the trademark SRA, which is a trademark of Weatherford International plc, 2000 St. James Place, Houston, Tex. 77056. to perform programmed pyrolysis in conjunction with a process to correct S1 using produced fluids from nearby wellbores. Both of the foregoing methods use standard programmed pyrolysis.

### SUMMARY

A method for analyzing in place movable oil in a fine grain rock formation according to one aspect includes extracting oil from a sample of a subsurface formation by heating the sample and evaluating its mobility components. The heating has a selected initial temperature, and a temperature increase at a selected rate to a final temperature. The thermally extracted oil is passed through a short uncoated capillary column to a flame ionization detector. Types of hydrocarbon and non-hydrocarbon compounds as well as fractional amounts of each type thereof are determined from the sample by analyzing a chemical thermogram generated by the flame ionization detector.

Other aspects and advantages will be apparent from the description an claims that follow.

### BRIEF DESCRIPTION OF THE DRAWINGS

FIG. 1 shows an example apparatus for carrying out analysis according to the present disclosure.

FIG. 2 shows an example form of chemical thermogram that may be generated by a thermal extraction with short uncoated capillary column and flame ionization detector.

FIG. 3 shows an example chemical thermogram having four peaks.

### DETAILED DESCRIPTION

In methods according to the present disclosure, a multi-step, high resolution thermal extraction/short uncoated column-flame ionization detector (MSHRTE/SUC-FID) may be used to sequentially liberate in-situ hydrocarbon and non-hydrocarbon oil components from specially collected and processed conventional-side wall core and/or drill cutting rock material. The MSHRTE procedures may use a low starting temperature, fixed isotherm period, unique ramp rate, and ending temperature below that at which kerogen or oil cracking may occur to characterize a full range of in-situ oil component groups (e.g., straight chain alkanes, branched alkanes, naphthenes, aromatics, heteroatoms-NSO, and asphaltenes). The MSHRTE is coupled to a flame ionization detector (FID) by a short, uncoated capillary column to generate additional separation in the thermal extraction profile (thermogram). The MSHRTE/SUC-FID thermogram signature (peak shape, area, and height) is examined for each key thermal fraction. A mobility ratio may be calculated and then calibrated for each formation.

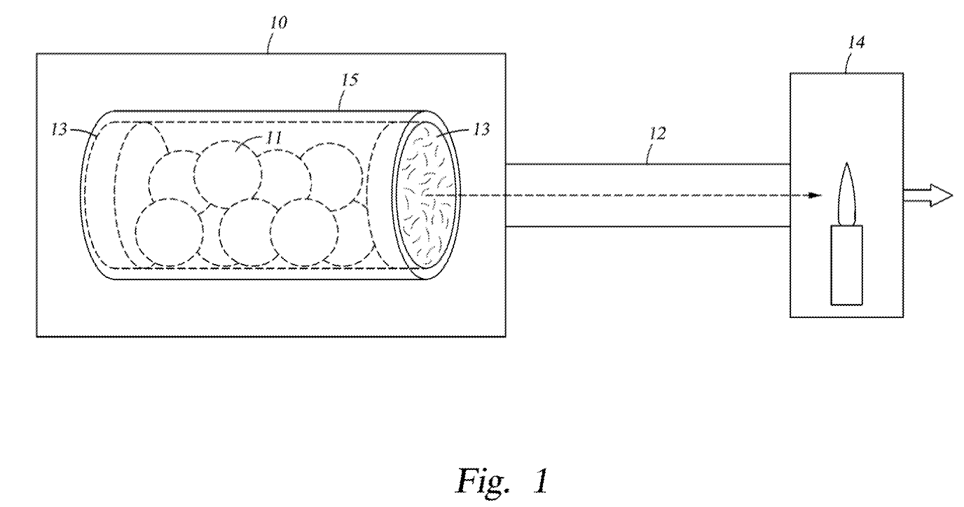

FIG. 1 shows an example apparatus that may be used in some embodiments. A high resolution thermal extractor (HRTE) 10 may be used to sequentially liberate in-situ hydrocarbon components from specially collected and processed fine grain rock samples 11 to minimize volatile hydrocarbon loss prior to analysis. An example HRTE 10 is sold by CDS Analytical, Inc. 465 Limestone Road, P.O. Box 277, Oxford, Pa. 19363-0277 under the model designation ACEM 9300 Series. Formation samples 11 from a subsurface formation or other sample of rock to be evaluated may be processed in the HRTE 10 as will be further explained below.

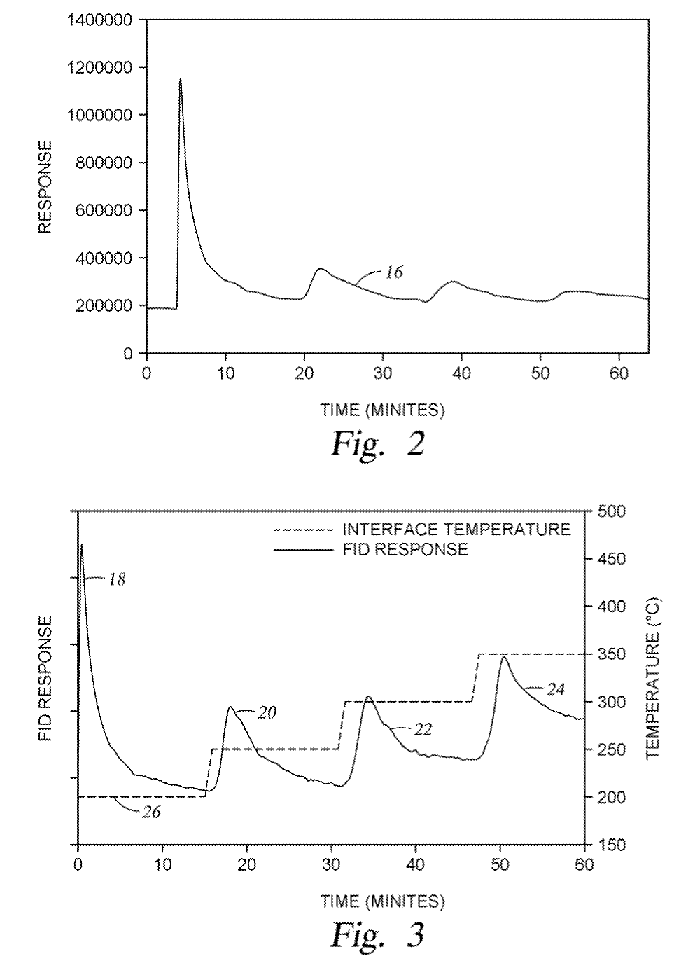

The HRTE 10 may be coupled to a flame ionization detector (FID) 14 by a short, uncoated capillary column 12. The column 12 may be a short length (1.0 m) of deactivated, uncoated fused silica (commonly referred to as a guard column). This uncoated column 12 will have a typical internal diameter of 0.10 mm. Such connection may generate additional hydrocarbon and non-hydrocarbon character separation in the thermal extraction profile (chemical thermogram). The FID 14 generates a chemical thermogram, as shown at 16 in FIG. 2. The character (peak shape, distribution, and height) and maximum temperature response in the chemical thermogram 16 may be calibrated for each identified hydrocarbon fraction using samples of known composition subjected to analysis in the FID 14 to estimate total oil in place in the subsurface formation and the fraction of the foregoing that is movable oil.

One or more samples of a subsurface formation may be obtained such as by extraction of a sidewall (percussion or drilled) core sample, a whole core (drilled, e.g., using an annular core drill bit) or by collection of drill cuttings returned to the surface from a wellbore during drilling. The one or more samples of rock material may sub-sampled, e.g., by depth interval or other sample segregation procedure. The one or more samples may be immediately wrapped in non-coated metal foil so as to minimize losses of volatile hydrocarbons. The wrapped samples of rock material may be placed in a pressure-sealed storage container and kept at reduced temperature conditions (approximately 2° C.) until processing according to the present disclosure.

The rock material samples may be initially processed by removal of contaminants and then grinding the rock material into a fine powder. The sequential thermal extraction may be performed using a modified thermal extraction unit. A quartz tube 15 is filled with a selected size sample of the rock material powder (20 milligrams in the present example). The quartz tube 15 may be protected at both ends with quartz wool 13. The quartz tube 15 with a set volume of powdered rock sample is placed in a probe (not shown separately). The probe is then inserted in the HRTE 10 where an optimized heater interface temperature program is used for the sequential thermal extraction program. The HRTE 10 may be operated by heating to a first temperature and holding the first temperature for a selected time. In some embodiments, the first temperature may be followed by increasing the temperature at a selected rate and holding the second temperature for a selected time. In other embodiments, holding the second temperature may be followed by subsequent increases in temperature at a selected rate followed by holding temperature at one or more additional higher temperatures for selected times until a final selected temperature is reached and held for a selected time. The HRTE 10 initial temperature in the present example embodiment is 200° C. held for 15 minutes. The initial temperature may followed by a temperature increase (ramp) of 60° C./minute until the temperature reaches a second temperature, in the present example 250° C., which is held for 15 minutes. Subsequently, the temperature of the HRTE 10 may be increased in successive ramps of 60° C./min and held for 15 minutes each at 300° C. for and 350° C.

At the same time, operation of the short uncoated column (SUC) flame ionization detector (FID) 14 is started. The FID 14 is coupled to the HRTE 10 using a deactivated, uncoated capillary column 12 having dimensions in the present example of 1 meter length, 0.25 millimeter internal diameter and wall thickness of about 75 micrometers. The SUC oven temperature was operated to maintain 300° C. for 65 minutes. Description of such an oven may be found in “Model 6890N Gas Chromatograph, User Information”, Part No. G1530-90210, Agilent Technologies, 5301 Stevens Creek Blvd, Santa Clara, Calif. 95051 (May 2001). An injector was operated in split mode (10:1) at a 270° C. The injector may be one sold by Agilent Technologies under model designation “7890/6890/6850 Split/Splitless Inlet.”

The foregoing multiple temperature, high resolution thermal extraction generates a chemical thermogram with four major peaks as shown in FIG. 3:

Peak 1: P_{200° C.} shown at 18

Peak 2: P_{250° C.} shown at 20.

Peak 3: P_{300° C.} shown at 22

Peak 4: P_{350° C.} shown at 24

The area underneath each peak (P1, P2, P3, and P4) using a defined baseline is quantified. Several MSHRTE Mobility Ratios may be calculated using the area under each peak P1, P2, P3, and P4 as shown below:

MSHRTE Mobility Ratio 1: P1_{200° C.}/P3_{300° C.}+P4_{350° C.}

MSHRTE Mobility Ratio 2: P1_{200° C.}/P1_{200° C.}+P3_{300° C.}+P4_{350° C.}

MSHRTE Mobility Ratio 3: P1_{200° C.}+P2_{250° C.}/P3_{300° C.}+P4_{350 ° C.}

The MSHRTE Mobility Ratios are calibrated to each prospective liquid rich resource target. The MSHRTE Mobility Ratios may be examined to evaluate the likely production from specific formation zones for horizontal well location with other important parameters and identify the more prospective zones for fracking stages (specific zones are injected with special fluid and proppant at a high pressure in order to induce in situ fractures to enhance production).

Specific compound identification can be achieved by coupling the MSHRTE to a conventional whole oil gas chromatograph wherein key compounds are quantified. Selected compounds are chosen based on their mobility to undertake a compound specific mobility ratio. Examples of selected calibration compounds are shown in TABLE 1.

TABLE 1

| Hydrocarbons | Target Compounds Ratio | Movability |
|---|---|---|
| Aromatics | Methyl-perylene/dimethyl | Less movable/ |
| | phenanthrene ratio | movable |
| Aliphatics | Heptacosane/tetradecane | Less movable/ |
| | ratio | movable |
| | Heptacosane ratio | Non movable/less |
| | | movable |

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for analyzing hydrocarbon and non-hydrocarbon compounds of oil in a formation sample, comprising:
extracting hydrocarbon and non-hydrocarbon compounds from a sample of a subsurface formation by heating the sample, the heating having a selected initial temperature, and a temperature increase at a selected rate to at least one final temperature;
passing the extracted hydrocarbon and non-hydrocarbon compounds through an uncoated capillary column to a flame ionization detector; and
determining types of hydrocarbon and non-hydrocarbon compounds and relative fractional amounts of each type thereof from the sample by analyzing a chemical thermogram generated by the flame ionization detector.

2. The method of claim 1 further comprising calibrating the chemical thermogram by analyzing known types of hydrocarbons and non-hydrocarbon compounds therein and generating a chemical thermogram for the known types.

3. The method of claim 1 wherein the capillary column comprises a deactivated, uncoated fused silica column.

4. The method of claim 1 wherein the extracting hydrocarbon and non-hydrocarbon compounds comprises heating the sample to the selected initial temperature held for a selected time, increasing the temperature at a selected ramp rate to at least a second temperature and holding the temperature at the second temperature for a selected time.

5. The method of claim 4 further comprising after holding the second temperature for a selected time increasing the temperature at a selected rate followed by holding temperature at one or more higher selected temperatures for selected times until a final selected temperature is reached and held for a selected time.

6. The method of claim 5 wherein the chemical thermogram is analyzed by determining an area under a plurality of peaks in a curve of the chemical thermogram with respect to a selected baseline, each peak corresponding to one of the selected temperatures.

7. The method of claim 5 further comprising determining at least one mobility ratio using a ratio of the area under a first one of the plurality peaks to the area under a second one of the plurality of peaks.

8. The method of claim 5 wherein the selected temperatures and selected times comprise the initial temperature being 200° C. held for 15 minutes followed by a temperature increase (ramp) of 60° C./minute until the temperature reaches 250° C. held for 15 minutes, followed by successive ramps of 60° C./minute and held for 15 minutes each at 300° C. and 350° C.

9. The method of claim 1 wherein the chemical thermogram is analyzed by determining an area under at least one peak in a curve of the chemical thermogram with respect to a selected baseline.
